(19) United States
(12) Patent Application Publication
(10) Pub. No.: US 2026/0167474 A1
(43) Pub. Date: Jun. 18, 2026

(54) Separate Valves-Controlled Gripper, Bottom-Supporting Gripper, and Loading-Unloading Robot

(71) Applicant: XYZ Robotics Global Inc., Grand Cayman (KY)

(72) Inventors: Shixuan Huang, Shanghai (CN); Xiaohua Zhang, Shanghai (CN); Qing Xu, Shanghai (CN); Jiaji Zhou, Shanghai (CN)

(21) Appl. No.: 19/349,955

(22) Filed: Oct. 4, 2025

(30) Foreign Application Priority Data
Dec. 16, 2024 (CN) 202411846120.3

(51) Int. Cl. B66F 9/18; B25J 15/06

(52) U.S. Cl. CPC B66F 9/181; B25J 15/0625

(57) ABSTRACT

Separate valves-controlled grippers, side-suction and bottom-supporting grippers, and loading-unloading robots are disclosed. The separate valves-controlled gripper includes a main mounting plate, a cavity structure, first mounting holes, second mounting holes, suckers, solenoid valves, and air holes. Each sucker may be individually controlled by a solenoid valve, making it adaptable to target boxes with different side surface areas, so that a plurality of suckers providing vacuum can be determined according to the length and width of a side surface of a target box, thereby avoiding suction of an adjacent target box. The loading-unloading robot may include a separate valves-controlled gripper, a robotic manipulator, and a mobile base, where the mobile base is used to drive the robotic manipulator to move.

### REFERENCE TO RELATED APPLICATIONS

This application claims priority under the Paris Convention to the following People's Republic of China (CN) patent application, which is incorporated by reference in its entirety herein, as if fully set forth herein: Patent Application No. CN 202411846120.3 (Docket No. XYZ-3003CN) filed on 16 Dec. 2024.

### TECHNICAL FIELD

The present invention relates to a loading-unloading robot, and in particular to a separate valves-controlled gripper, a bottom-supporting gripper, and a loading-unloading robot.

### BACKGROUND OF THE INVENTION

Loading-unloading robots are intelligent devices equipped with sensors, objective lenses, and electro-optical systems, which can quickly sort and transport materials.

More and more visual sensors and force sensors will be used in the loading-unloading robots, and the loading-unloading robots will become increasingly intelligent. With the advancement of sensing and identification systems, artificial intelligence, and other technologies, robots have evolved from being controlled unidirectionally to storing and applying data on their own, thereby gradually becoming information-focused.

When sorting and transporting materials through a loading-unloading robot, it is necessary to collect images of the materials through a visual sensor, and identify the images of the materials to determine postures thereof, and then the loading-unloading robot sorts or transports the materials through its mounted gripper or suckers.

When using a loading-unloading robot to unload materials in containers with borders, top plates and partitions layers, such as material boxes, shelves and roll cages, it is necessary to grasp one side surface of the materials. However, when the size of the materials is smaller than the size of the gripper, two adjacent materials will often be sucked. Not only does it require the replacement of a gripper with a different size, but it also often causes adjacent materials to be accidentally pulled down.

### BRIEF SUMMARY OF THE INVENTION

In view of the defects in the prior art, the present invention aims to provide a separate valves-controlled gripper, a bottom-supporting gripper and a loading-unloading robot.

The separate valves-controlled gripper according to the present invention includes: a main mounting plate, where a cavity structure is formed in the main mounting plate, a plurality of first mounting holes in a matrix arrangement are provided on a front side surface of the main mounting plate, and a plurality of second mounting holes in a matrix arrangement are provided on a back side surface of the main mounting plate; suckers, which are provided in the first mounting holes; solenoid valves, which are provided in the second mounting holes; where air holes of the suckers are in communication with or disconnected from the cavity structure through the solenoid valves.

In an embodiment, when the air holes of the suckers are in communication with the cavity structure, suction forces can be applied to the suckers through the cavity structure; when the air holes of the suckers are disconnected from the cavity structure, suction forces cannot be applied to the suckers through the cavity structure.

In an embodiment, the separate valves-controlled gripper further includes a vacuum connector; where an air suction hole in communication with the cavity structure is provided on the back side surface of the main mounting plate; the vacuum connector is in communication with the cavity structure through the air suction hole; the vacuum connector is used to be in communication with a vacuum source, so as to provide vacuum to the cavity structure.

In an embodiment, the separate valves-controlled gripper further includes a controller unit; where the controller unit is electrically connected to each of the solenoid valves to control on and off of each of the solenoid valves, and each of the solenoid valves is provided in correspondence with one of the suckers.

In an embodiment, the separate valves-controlled gripper further includes a rear cover; where the rear cover is connected to the back side surface of the main mounting plate to form an accommodation space; a communication notification board in the controller unit and the solenoid valves are located within the accommodation space.

The bottom-supporting gripper according to the present invention includes the separate valves-controlled gripper, and further includes: a gripper main structure; a sucker structure, which is provided with the separate valves-controlled gripper, where the separate valves-controlled gripper is used to suck a target box, and the sucker structure is provided on the gripper main structure and is movable in a first direction; a bottom-supporting mechanism, which is located on the gripper main structure, and which is movable in a second direction opposite to the first direction; an actuator module, which is connected to the sucker structure and the bottom-supporting mechanism through a driving transmission mechanism, and which is used to drive the sucker structure and the bottom-supporting mechanism to move in opposite directions simultaneously.

In an embodiment, when the separate valves-controlled gripper grips the target box by applying suction, the actuator module drives the separate valves-controlled gripper to move from a front end of the gripper main structure to a rear end of the gripper main structure, and the bottom-supporting mechanism protrudes from the front end of the gripper main structure; when releasing the target box, the actuator module drives the separate valves-controlled gripper to move from the rear end of the gripper main structure to the front end of the gripper main structure to push out the target box, while the bottom-supporting mechanism retracts into the gripper main structure.

In an embodiment, the driving transmission mechanism includes a driving wheel, a driven wheel, and a transmission belt; the driving wheel is provided on a transmission shaft of the actuator module; the driven wheel is provided at the front end of the gripper main structure; the driving wheel is connected to the driven wheel through the transmission belt; the sucker structure is connected to one side of the transmission belt, and the bottom-supporting mechanism is connected to the other side of the transmission belt.

In an embodiment, the gripper main structure includes a supporting base structure and a vertical installation plate; the vertical installation plate is connected to a rear end of the supporting base structure, and the vertical installation plate is provided with a robot connecting flange; the supporting base structure is provided with a gripper guiding mechanism and a bottom-supporting and guiding mechanism; the bottom-supporting mechanism is provided on the bottom-supporting and guiding mechanism and is capable of sliding along the bottom-supporting and guiding mechanism; the sucker structure is provided on the gripper guiding mechanism and is capable of sliding along the gripper guiding mechanism.

In an embodiment, the gripper guiding mechanism includes a first guide rail, a first slider, a second guide rail and a second slider; the first guide rail and the second guide rail are provided on a pair of supporting rods of the supporting base structure, the sucker structure is connected to the first guide rail through the first slider, is connected to the second guide rail through the second slider, and is capable of sliding along the first guide rail and the second guide rail.

In an embodiment, the bottom-supporting and guiding mechanism includes a third guide rail, a third slider, a fourth guide rail and a fourth slider; the third guide rail and the fourth guide rail are provided on another pair of supporting rods of the supporting base structure, the bottom-supporting mechanism is connected to the third guide rail through the third slider, is connected to the fourth guide rail through the fourth slider, and is capable of sliding along the third guide rail and the fourth guide rail.

In an embodiment, the bottom-supporting mechanism includes a guiding rod, a first bottom-supporting plate, a first connecting plate, a second bottom-supporting plate, and a second connecting plate; front ends of the first bottom-supporting plate and the second bottom-supporting plate are connected to the guiding rod; the first bottom-supporting plate is connected to the third slider through the first connecting plate; the second bottom-supporting plate is connected to the fourth slider through the second connecting plate.

In an embodiment, the actuator module includes a driving motor, a power output gear, a power transmission gear, and a transmission shaft; the driving motor is provided at a lower side of the gripper main structure, and the transmission shaft is provided on a plurality of bearings at the rear end of the gripper main structure; the power transmission gear is provided on the transmission shaft; the driving motor is used to drive the transmission shaft to rotate through the power output gear and the power transmission gear in sequence.

In an embodiment, the supporting base structure includes a front supporting frame, a rear supporting frame, a first supporting rod, a second supporting rod, a third supporting rod and a fourth supporting rod; a front end of the first supporting rod is connected to one end of the front supporting frame, and a rear end of the first supporting rod is connected to one end of the rear supporting frame; a front end of the second supporting rod is connected to the other end of the front supporting frame, and a rear end of the second supporting rod is connected to the other end of the rear supporting frame; the third supporting rod and the fourth supporting rod are provided between the first supporting rod and the second supporting rod, and a front end of the third supporting rod is connected to the front supporting frame, and a rear end of the third supporting rod is connected to the rear supporting frame; a front end of the fourth supporting rod is connected to the front supporting frame, and a rear end of the fourth supporting rod is connected to the rear supporting frame.

The loading-unloading robot according to the present invention includes the separate valves-controlled gripper or the bottom-supporting gripper, and further includes a robotic manipulator and a mobile base; the separate valves-controlled gripper or the bottom-supporting gripper is provided at an end of the robotic manipulator; the robotic manipulator is provided on the mobile base, and the mobile base is used to drive the robotic manipulator to move.

Compared with the prior art, the present invention has the following beneficial effects:

In the present invention, each sucker can be individually controlled by a solenoid valve, making it adaptable to target boxes with different side surface areas, so that a plurality of suckers providing vacuum can be determined according to the length and width of a side surface of a target box, thereby avoiding suction of an adjacent target box.

In the present invention, the gripper main structure is provided with a gripper guiding mechanism and a bottom-supporting and guiding mechanism extending along the length direction. The sucker structure is connected to the gripper guiding mechanism and capable of sliding along the gripper guiding mechanism, and the bottom-supporting mechanism is connected to the bottom-supporting and guiding mechanism and capable of sliding along the bottom-supporting and guiding mechanism. When the sucker array provided on the sucker structure sucks a target box, the sucker structure is driven by the actuator module to move towards the rear end of the gripper main structure to realize the fetching of the target box. At the same time, the actuator module drives the bottom-supporting mechanism to protrude from the front end of the gripper main structure to support the target box. Therefore, the loading, unloading, and palletizing and de-palletizing of the box can be achieved in environments with limited space such as containers.

### BRIEF DESCRIPTION OF THE DRAWINGS

In order to provide a clearer explanation to the technical solutions in the embodiments of the present invention or the prior art, a brief introduction will be given hereunder to the accompanying drawings required for the description of the embodiments or the prior art. It is obvious that the accompanying drawings described below are only embodiments of the present invention. For those of ordinarily skilled in the art, other drawings can be obtained based on the provided drawings without creative labor. By reading the detailed description of non-limiting embodiments with reference to the following figures, other features, objectives, and advantages of the present invention will become more apparent.

FIG. 1 is a schematic structural diagram of a separate valves-controlled gripper according to an embodiment of the present invention.

FIG. 2 is a schematic structural diagram of a backplate of a separate valves-controlled gripper according to an embodiment of the present invention.

FIG. 3 is a schematic cross-sectional view of a separate valves-controlled gripper according to an embodiment of the present invention.

FIG. 4 is a schematic structural diagram of a bottom-supporting gripper according to an embodiment of the present invention.

FIG. 5 is a schematic state diagram of a bottom-supporting gripper according to an embodiment of the present invention.

FIG. 6 is another schematic state diagram of a bottom-supporting gripper according to an embodiment of the present invention.

FIG. 7 is a schematic diagram of a working state of a bottom-supporting gripper according to an embodiment of the present invention.

FIG. 8 shows a schematic structural diagram of a bottom-supporting mechanism according to an embodiment of the present invention.

FIG. 9 shows a schematic structural diagram of a gripper main structure according to an embodiment of the present invention.

FIG. 10 shows a schematic structural diagram of an actuator module according to an embodiment of the present invention.

FIG. 11 shows a schematic structural diagram of a driving transmission mechanism according to an embodiment of the present invention.

FIG. 12 is a schematic structural diagram of a loading-unloading robot according to an embodiment of the present invention.

### IN THE FIGURES

1—Gripper main structure; 101—Vertical installation plate; 1021—Front supporting frame; 1022—Rear supporting frame; 1023—First supporting rod; 1024—Second supporting rod; 1025—Third supporting rod; 1026—Fourth supporting rod; 2—Separate valves—controlled gripper; 201—Main mounting plate; 202—Sucker; 203—Solenoid valve; 204—Cavity structure; 205—Communication notification board; 206—Vacuum connector; 207—Rear cover; 208—Sucker structure; 3—Bottom-supporting mechanism; 301—Guiding rod; 302—First bottom-supporting plate; 303—First connecting plate; 304—Second bottom-supporting plate; 4—Actuator module; 401—Driving motor; 402—Power output gear; 403—Power transmission gear; 404—Transmission shaft; 405—Driving wheel; 406—Driven wheel; 407—Transmission belt; 408—First transmission block fixture; 409—Second transmission block fixture; 5—Gripper guiding mechanism; 6—Bottom-supporting and guiding mechanism; 100—Bottom-supporting gripper; 200—Robotic manipulator; 300—Mobile base.

### DETAILED DESCRIPTION OF THE INVENTION

A detailed explanation of the present invention will be provided below in conjunction with specific embodiments. The following embodiments will help those skilled in the art further understand the present invention, but do not limit the present invention in any form. It should be pointed out that for those ordinarily skilled in the art, several modifications and improvements can be made without departing from the disclosed concept. These are all within the protection scope of the present invention.

The terms “first,” “second,” “third,” “fourth,” etc. (if any) in the description, the claims, and the accompanying drawings of the present invention are intended to distinguish similar objects and do not necessarily describe a specific order or sequence. It should be understood that data used in this way can be interchanged in appropriate circumstances, so that the embodiments described herein can be implemented in an order other than those illustrated or described herein. In addition, the terms “including” and “having” as well as any variations thereof, are intended to cover non-exclusive inclusions, for example, processes, methods, systems, products, or devices that contain a series of steps or units are not necessarily limited to those steps or units that are clearly listed, but may include other steps or units that are not clearly listed or inherent to these processes, methods, products, or devices.

The following provides a detailed explanation to the disclosed technical solution through specific embodiments. The following specific embodiments can be combined with each other, and the same or similar concepts or processes may not be repeated in some embodiments.

With specific embodiments, detailed explanations are given hereunder to the disclosed technical solution and how the technical solution of the present application solves the above technical problems. The following specific embodiments can be combined with each other, and the same or similar concepts or processes may not be repeated in some embodiments. The following will describe the embodiments disclosed herein in conjunction with the accompanying drawings.

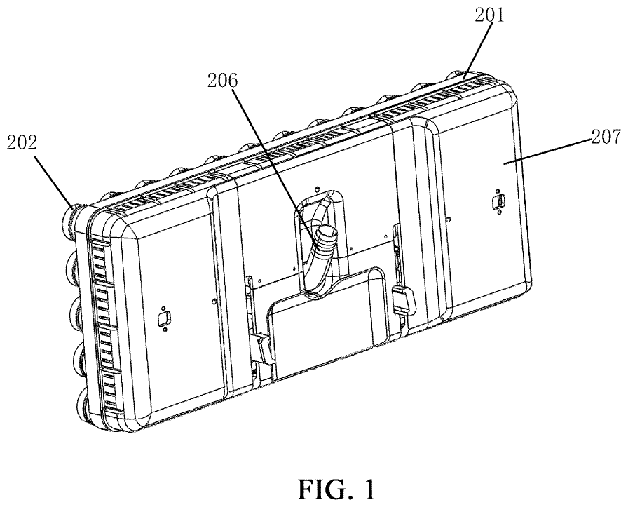

FIG. 1 is a schematic structural diagram of a separate valves-controlled gripper in an embodiment of the present invention. As shown in FIG. 1, the separate valves-controlled gripper 2 provided in the present invention includes: a main mounting plate 201, where a cavity structure 204 is formed in the main mounting plate 201, a plurality of first mounting holes in a matrix arrangement are provided on a front side surface of the main mounting plate 201, and a plurality of second mounting holes in a matrix arrangement are provided on a back side surface of the main mounting plate 201; suckers 202, which are provided in the first mounting holes; and solenoid valves 203, which are provided in the second mounting holes; where air holes of the suckers 202 are in communication with or disconnected from the cavity structure 204 through the solenoid valves 203.

In the embodiments of the present invention, the solenoid valves 203 are provided in a one-to-one correspondence with the suckers 202. When the air holes of the suckers 202 are in communication with the cavity structure 204, suction forces can be applied to the suckers 202 through the cavity structure 204; and when the air holes of the suckers 202 are disconnected from the cavity structure 204, suction forces cannot be applied to the suckers 202 through the cavity structure 204.

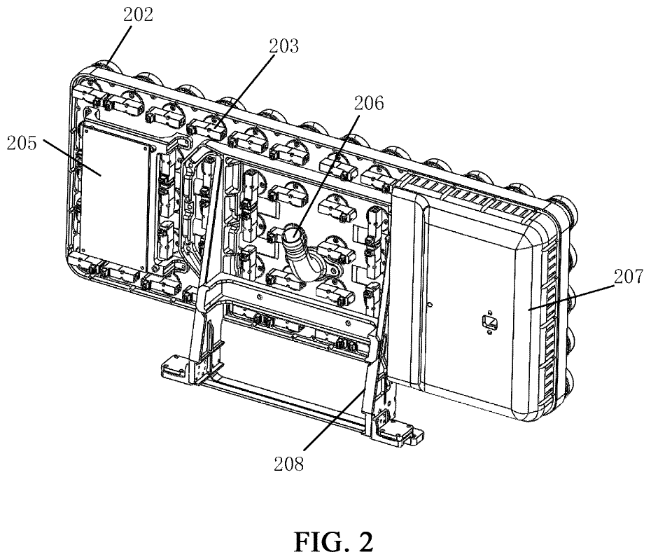

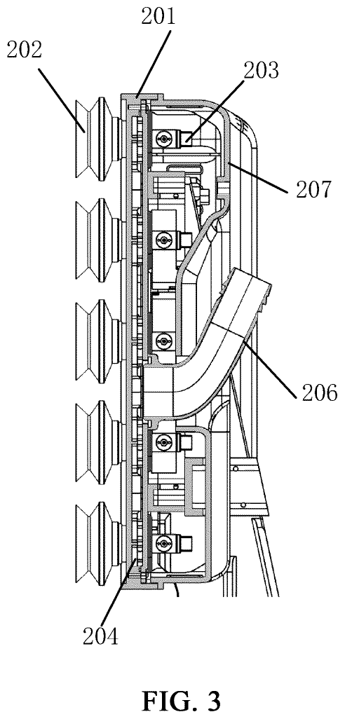

FIG. 2 is a schematic structural diagram of a back plate of a separate valves-controlled gripper in an embodiment of the present invention, and FIG. 3 is a schematic cross-sectional view of a separate valves-controlled gripper in an embodiment of the present invention. As shown in FIG. 2 and FIG. 3, the separate valves-controlled gripper 2 provided in the present invention further includes a vacuum connector 206, a controller unit and a rear cover 207.

An air suction hole in communication with the cavity structure 204 is provided on the back side surface of the main mounting plate 201; and the vacuum connector 206 is in communication with the cavity structure 204 through the air suction hole.

The vacuum connector 206 is used to be in communication with a vacuum source, so as to provide vacuum to the cavity structure 204.

The controller unit is electrically connected to each of the solenoid valves 203 to control on and off of each of the solenoid valves 203, and each of the solenoid valves 203 is provided in correspondence with one of the suckers 202.

In the embodiments of the present invention, the controller unit includes a communication notification board 205, the communication notification board 205 is electrically connected to an industrial control computer, the communication notification board 205 includes an STM32 chip, and the STM32 chip drives MOS transistors through multiple DO ports to control each of the solenoid valves 203, with one DO port dedicated to controlling one solenoid valve 203.

The rear cover 207 is connected to the back side surface of the main mounting plate 201 to form an accommodation space; and a communication notification board 205 in the controller unit and the solenoid valves 203 are located within the accommodation space.

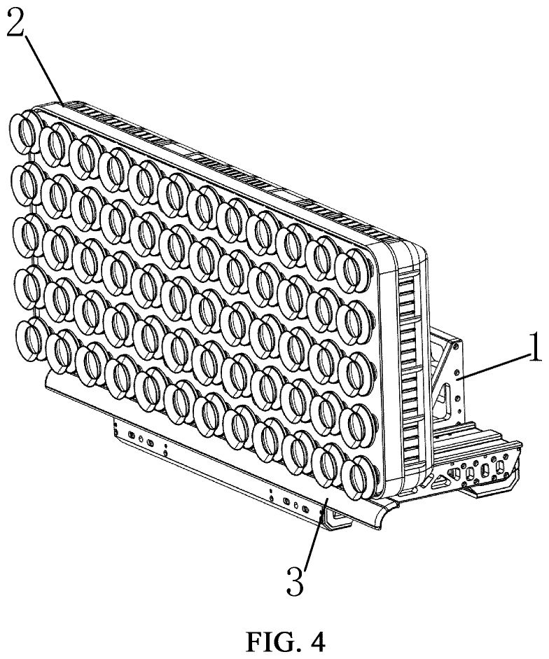

FIG. 4 is a schematic structural diagram of a bottom-supporting gripper or a side-suction and bottom-supporting gripper in an embodiment of the present invention. As shown in FIG. 4, the bottom-supporting gripper 100 provided in the present invention includes the separate valves-controlled gripper 2, and further includes: a gripper main structure 1; a sucker structure 208 provided with the separate valves-controlled gripper 2, where the separate valves-controlled gripper 2 is used to suck a target box, and the sucker structure 208 is provided on the gripper main structure 1 and is movable in a first direction; a bottom-supporting mechanism 3, which is located on the gripper main structure 1, and which is movable in a second direction opposite to the first direction; and an actuator module 4, which is connected to the sucker structure 208 and the bottom-supporting mechanism 3 through a driving transmission mechanism, and which is used to drive the sucker structure 208 and the bottom-supporting mechanism 3 to move in opposite directions simultaneously.

In the embodiments of the present invention, the actuator module 4 adopts a driving motor or cylinder.

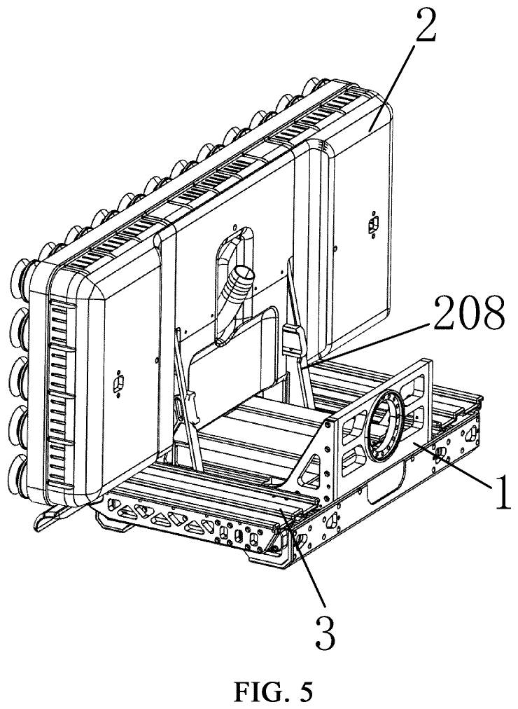

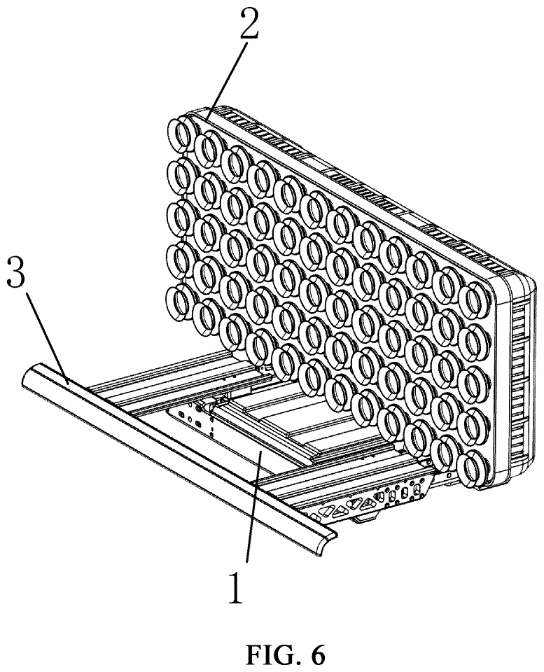

FIG. 5 is a schematic state diagram of a bottom-supporting gripper in an embodiment of the present invention, and FIG. 6 is another schematic state diagram of a bottom-supporting gripper in an embodiment of the present invention, as shown in FIG. 5 and FIG. 6.

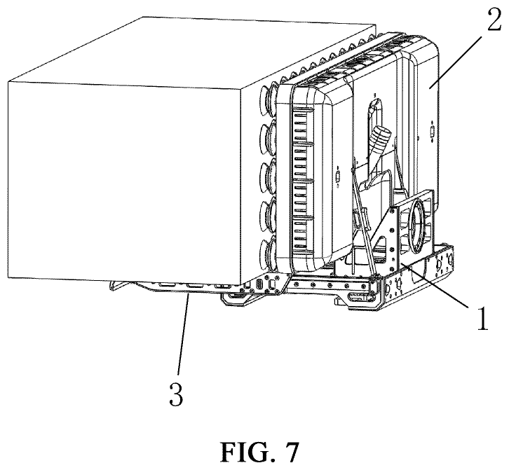

When the separate valves-controlled gripper 2 grips the target box by applying suction, the actuator module 4 drives the separate valves-controlled gripper 2 to move from a front end of the gripper main structure 1 to a rear end of the gripper main structure 1, and the bottom-supporting mechanism 3 protrudes from the front end of the gripper main structure 1, as shown in FIG. 7.

When releasing the target box, the actuator module 4 drives the separate valves-controlled gripper 2 to move from the rear end of the gripper main structure 1 to the front end of the gripper main structure 1 to push out the target box, while the bottom-supporting mechanism 3 retracts into the gripper main structure 1.

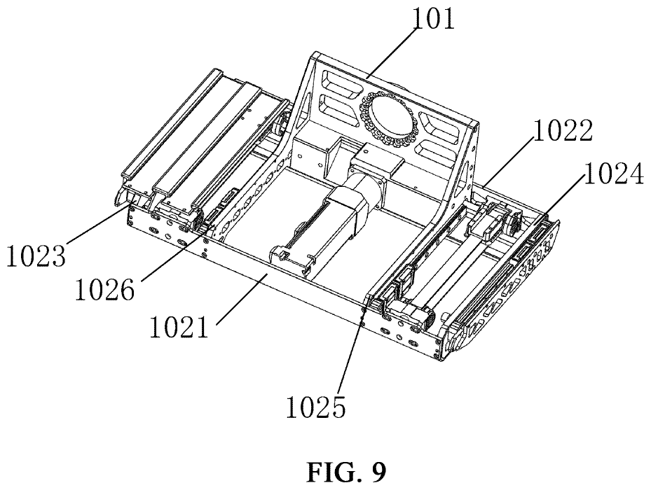

FIG. 9 shows a schematic structural diagram of a gripper main structure in an embodiment of the present invention. As shown in FIG. 9, the gripper main structure 1 includes a supporting base structure and a vertical installation plate 101.

The vertical installation plate 101 is connected to a rear end of the supporting base structure, and the vertical installation plate 101 is provided with a robot connecting flange for connecting an end of a robotic manipulator. The supporting base structure is provided with a gripper guiding mechanism 5 and a bottom-supporting and guiding mechanism 6. The bottom-supporting mechanism 3 is provided on the bottom-supporting and guiding mechanism 6 and is capable of sliding along the bottom-supporting and guiding mechanism 6; and the sucker structure 208 is provided on the gripper guiding mechanism 5 and is capable of sliding along the gripper guiding mechanism 5.

In the embodiments of the present invention, the gripper guiding mechanism 5 includes a first guide rail, a first slider, a second guide rail and a second slider. The first guide rail and the second guide rail are provided on a pair of supporting rods of the supporting base structure, the sucker structure 208 is connected to the first guide rail through the first slider, is connected to the second guide rail through the second slider, and is capable of sliding along the first guide rail and the second guide rail.

The bottom-supporting and guiding mechanism 6 includes a third guide rail, a third slider, a fourth guide rail and a fourth slider. The third guide rail and the fourth guide rail are provided on another pair of supporting rods of the supporting base structure, the bottom-supporting mechanism 3 is connected to the third guide rail through the third slider, is connected to the fourth guide rail through the fourth slider, and is capable of sliding along the third guide rail and the fourth guide rail. The first guide rail and the second guide rail are parallel to each other; and the third guide rail and the fourth guide rail are parallel to each other.

In an embodiment of the present invention, the supporting base structure includes a front supporting frame 1021, a rear supporting frame 1022, a first supporting rod 1023, a second supporting rod 1024, a third supporting rod 1025 and a fourth supporting rod 1026.

A front end of the first supporting rod 1023 is connected to one end of the front supporting frame 1021, and a rear end of the first supporting rod 1023 is connected to one end of the rear supporting frame 1022; and a front end of the second supporting rod 1024 is connected to the other end of the front supporting frame 1021, and a rear end of the second supporting rod 1024 is connected to the other end of the rear supporting frame 1022.

The third supporting rod 1025 and the fourth supporting rod 1026 are provided between the first supporting rod 1023 and the second supporting rod 1024, and a front end of the third supporting rod 1025 is connected to the front supporting frame 1021, and a rear end of the third supporting rod 1025 is connected to the rear supporting frame 1022; and a front end of the fourth supporting rod 1026 is connected to the front supporting frame 1021, and a rear end of the fourth supporting rod 1026 is connected to the rear supporting frame 1022.

In the embodiments of the present invention, the front supporting frame 1021, the rear supporting frame 1022, the first supporting rod 1023 and the second supporting rod 1024 form a rectangular frame structure; the third supporting rod 1025 and the fourth supporting rod 1026 are provided between the first supporting rod 1023 and the second supporting rod 1024; the first supporting rod 1023, the second supporting rod 1024, the third supporting rod 1025 and the fourth supporting rod 1026 are provided in parallel.

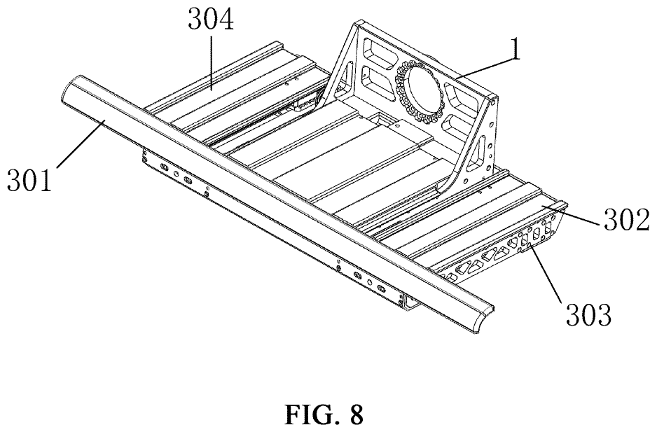

FIG. 8 shows a schematic structural diagram of a bottom-supporting mechanism in an embodiment of the present invention. As shown in FIG. 8, the bottom-supporting mechanism 3 includes a guiding rod 301, a first bottom-supporting plate 302, a first connecting plate 303, a second bottom-supporting plate 304, and a second connecting plate.

Front ends of the first bottom-supporting plate 302 and the second bottom-supporting plate 304 are connected to the guiding rod 301. The first bottom-supporting plate 302 is connected to the third slider through the first connecting plate 303. The second bottom-supporting plate 304 is connected to the fourth slider through the second connecting plate.

In the embodiments of the present invention, the first bottom-supporting plate 302 and the second bottom-supporting plate 304 are provided in parallel and perpendicular to the guiding rod 301. The first connecting plate 303 is perpendicular to the first bottom-supporting plate 302 and is located at an outer end of the first connecting plate 303. The second connecting plate is perpendicular to the second bottom-supporting plate 304 and is located at an outer end of the second connecting plate.

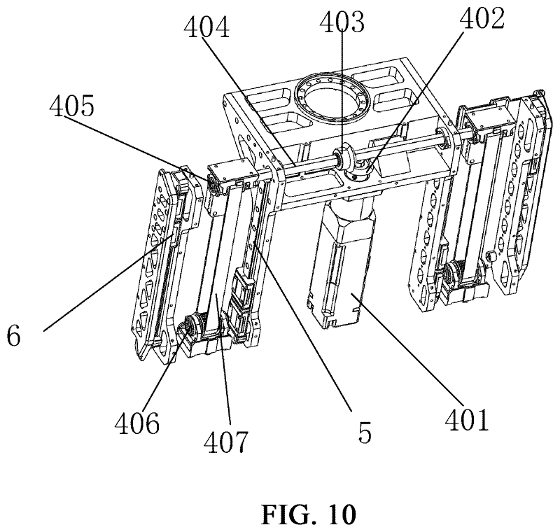

FIG. 10 shows a schematic structural diagram of an actuator module in an embodiment of the present invention. As shown in FIG. 10, the actuator module 4 includes a driving motor 401, a power output gear 402, a power transmission gear 403 and a transmission shaft 404. The driving motor 401 is provided at a lower side of the gripper main structure 1, and the transmission shaft 404 is provided on a plurality of bearings at the rear end of the gripper main structure 1.

The power transmission gear 403 is provided on the transmission shaft 404; and the driving motor 401 is used to drive the transmission shaft 404 to rotate through the power output gear 402 and the power transmission gear 403 in sequence. The transmission shaft 404 then drives a driving wheel 405 to rotate.

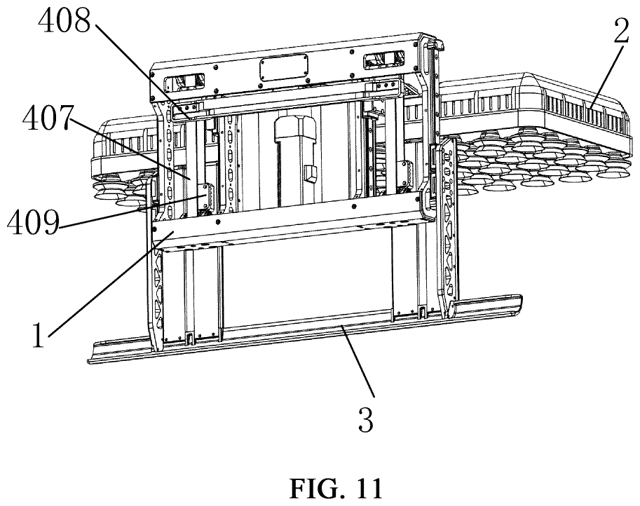

FIG. 11 shows a schematic structural diagram of a driving transmission mechanism in an embodiment of the present invention. As shown in FIG. 10 and FIG. 11, the driving transmission mechanism includes: a driving wheel 405, a driven wheel 406, and a transmission belt 407.

The driving wheel 405 is provided on the transmission shaft 404 of the actuator module 4. The driven wheel 406 is provided at the front end of the gripper main structure 1; and the driving wheel 405 is connected to the driven wheel 406 through the transmission belt 407. The sucker structure 208 is connected to one side of the transmission belt 407, and the bottom-supporting mechanism 3 is connected to the other side of the transmission belt 407.

In the embodiments of the present invention, the sucker structure 208 is connected to a lower side of the transmission belt 407 through a second transmission block fixture 409; and the bottom-supporting mechanism 3 is connected to an upper side of the transmission belt 407 through a first transmission block fixture 408.

In the embodiments of the present invention, the separate valves-controlled gripper 2 includes a plurality of sucker regions arranged adjacent to each other. Each of the sucker regions is used to provide suction separately to suck a target box of one size at a side surface or to simultaneously provide suction either entirely or partially to suck a target box of another size at a side surface. That is, by controlling the separate valves-controlled gripper 2 in different regions, it is possible to suck a target box with small area at a side surface, that is, suction on a side surface of a target box with a certain area is performed by separately controlling each of the sucker regions, avoiding traction on an adjacent target box. At this time, the area of said sucker region is smaller than that of the sucked surface of the target box.

In an embodiment of the present invention, the plurality of sucker regions have the same height, but the width of the plurality of sucker regions is smaller than that of the separate valves-controlled gripper 2, and thus can be used to suck a target box whose width is smaller than that of the separate valves-controlled gripper 2.

In an embodiment of the present invention, since each sucker can be individually controlled by a solenoid valve 203, any one or more of the plurality of sucker regions can be controlled to perform vacuum suction simultaneously. In a word, whether to choose the separate valves-controlled gripper 2 or any one or more of the plurality of sucker regions depends on the area of the side surface of the target box being sucked. Generally, the sucker region needs to be fully adhered to the side surface being sucked and is able to provide sufficient suction to suck the target box up.

In a variant embodiment of the present invention, the bottom-supporting gripper 100 provided in the present invention includes: a gripper main structure 1; a sucker structure 208, which is provided with the separate valves-controlled gripper 2, where the separate valves-controlled gripper 2 is used to suck a target box, and the sucker structure 208 is provided on the gripper main structure 1 and is movable in a first direction; a bottom-supporting mechanism 3, which is located on the gripper main structure 1, and which is movable in a second direction opposite to the first direction; a first driving unit, which is used to drive the sucker structure 208 to move along the gripper guiding mechanism 5; and a second driving unit, which is used to drive the bottom-supporting mechanism 3 to move along the bottom-supporting and guiding mechanism 6, where the sucker structure 208 and the bottom-supporting mechanism 3 move in opposite directions.

In this variant embodiment, the sucker structure 208 and the bottom-supporting mechanism 3 are driven by different driving units. The sucker structure 208 and the bottom-supporting mechanism 3 can be controlled, by a controller, to move in opposite directions simultaneously, or the sucker structure 208 can also be controlled to move several seconds before the bottom-supporting mechanism 3, or the sucker structure 208 can also be controlled to move several seconds later than the bottom-supporting mechanism 3. The several seconds can be any one of 1 to 3 seconds, such as two seconds.

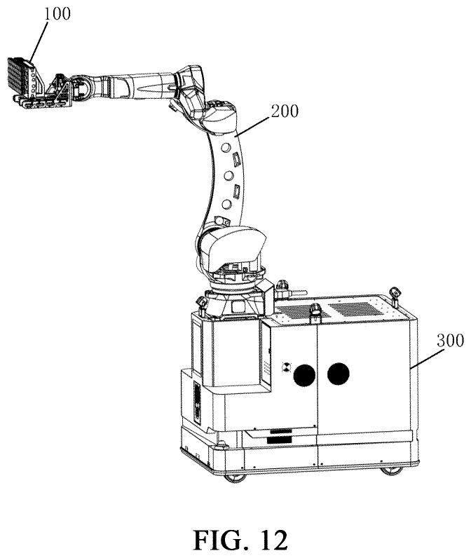

FIG. 12 is a schematic structural diagram of a loading-unloading robot in an embodiment of the present invention. As shown in FIG. 12, the loading-unloading robot provided in the present invention includes the separate valves-controlled gripper 2 or the bottom-supporting gripper 100, and further includes a robotic manipulator 200 and a mobile base 300.

The separate valves-controlled gripper 2 or the bottom-supporting gripper 100 is provided at an end of the robotic manipulator 200; and the robotic manipulator 200 is provided on the mobile base 300, and the mobile base 300 is used to drive the robotic manipulator 200 to move.

When using the loading-unloading robot provided in the present invention to unload the target box, the following steps are included:
Step S1: control the sucker structure 208 to move to the front end of the gripper main structure 1 to suck a target box at a side surface;
Step S2: control the actuator module 4 to drive the sucker structure 208 to move from the front end of the gripper main structure 1 to the rear end of the gripper main structure 1, while the bottom-supporting mechanism 3 protrudes from the front end of the gripper main structure 1 to support the target box;
Step S3: control the actuator module 4 to drive the sucker structure 208 to move from the rear end of the gripper main structure 1 to the front end of the gripper main structure 1, to push out the target box, while the bottom-supporting mechanism 3 retracts into the gripper main structure 1.

More specifically, the following steps are included: obtain a stack image of a box stack, identify the stack image, and determine multiple target box regions on the stack image; based on positions of the multiple target box regions, determine multiple target boxes to be sucked, and further determine length and height of the target boxes; when the height of the to-be-sucked side surface is greater than the height of the separate valves-controlled gripper 2 and the length of the to-be-sucked side surface is greater than the length of the separate valves-controlled gripper 2, the target box is sucked by the separate valves-controlled gripper 2; when the height of the to-be-sucked side surface is greater than the height of the separate valves-controlled gripper 2 and the length of the to-be-sucked side surface is smaller than the length of the separate valves-controlled gripper 2, the target box is sucked by a sucker region of the separate valves-controlled gripper 2.

In the embodiments of present invention, each sucker 202 can be individually controlled by a solenoid valve 203, making it adaptable to target boxes with different side surface areas, so that a plurality of suckers 202 providing vacuum can be determined according to the length and width of a side surface of a target box, thereby avoiding suction of an adjacent target box. The gripper main structure 1 is provided with a gripper guiding mechanism 5 and a bottom-supporting and guiding mechanism 6 extending along the length direction. The sucker structure 208 is connected to the gripper guiding mechanism 5 and is capable of sliding along the gripper guiding mechanism 5, and the bottom-supporting mechanism 3 is connected to the bottom-supporting and guiding mechanism 6 and is capable of sliding along the bottom-supporting and guiding mechanism 6. When the sucker array provided on the sucker structure 208 sucks a target box, the sucker structure 208 is driven by the actuator module 4 to move towards the rear end of the gripper main structure 1 to achieve the fetching of the target box. At the same time, the actuator module 4 drives the bottom-supporting mechanism 3 to protrude from the front end of the gripper main structure 1 to support the target box. Therefore, the loading, unloading, and palletizing and de-palletizing of the boxes can be achieved in environments with limited space such as containers.

The various embodiments in the present specification are described in a progressive manner, with each embodiment emphasizing its differences from other embodiments. Cross reference can be made to the embodiments for the same and similar parts therebetween. The above description of the disclosed embodiments enables those skilled in this field to implement or use the present invention. Various modifications to these embodiments will become apparent to those skilled in the art, and the general principles defined in this article can be implemented in other embodiments without departing from the spirit or scope of the present invention. Therefore, the present invention will not be limited to the embodiments shown herein, but will be within the widest scope consistent with the principles and novel features disclosed herein.

The specific embodiments of the present invention have been described above. It should be understood that the present invention is not limited to the specific embodiments described above. Those skilled in the art may make various modifications or alterations within the scope of the claims, which does not affect the substantive content of the present invention.

What is claimed is:

1. A separate valves-controlled gripper, comprising:
a main mounting plate, wherein a cavity structure is formed in the main mounting plate, wherein a plurality of first mounting holes in a first matrix arrangement are provided on a front side surface of the main mounting plate, and wherein a plurality of second mounting holes in a second matrix arrangement are provided on a back side surface of the main mounting plate;
a plurality of suckers, wherein the plurality of suckers is provided in the plurality of first mounting holes; and
a plurality of solenoid valves, wherein the plurality of solenoid valves are provided in the plurality of second mounting holes, and wherein a plurality of air holes of the plurality of suckers are in communication with or disconnected from the cavity structure through the plurality of solenoid valves.

2. The separate valves-controlled gripper of claim 1,
wherein when the plurality of air holes of the plurality of suckers are in communication with the cavity structure, a plurality of suction forces can be applied to the plurality of suckers through the cavity structure; and
wherein when the plurality of air holes of the plurality of suckers are disconnected from the cavity structure, the plurality of suction forces cannot be applied to the plurality of suckers through the cavity structure.

3. The separate valves-controlled gripper of claim 1, further comprising:
a vacuum connector,
wherein an air suction hole in communication with the cavity structure is provided on the back side surface of the main mounting plate,
wherein the vacuum connector is in communication with the cavity structure through the air suction hole, and
wherein the vacuum connector is used to be in communication with a vacuum source, so as to provide a vacuum to the cavity structure.

4. The separate valves-controlled gripper of claim 1, further comprising:
a controller unit,
wherein the controller unit is electrically connected to each of the solenoid valves in the plurality of solenoid valves to control on and off each of the solenoid valves in the plurality of solenoid vales, and
wherein each of the solenoid valves in the plurality of solenoid valves is provided in correspondence with one of the suckers in the plurality of suckers.

5. The separate valves-controlled gripper of claim 4, further comprising:
a rear cover,
wherein the rear cover is connected to the back side surface of the main mounting plate to form an accommodation space, and
wherein a communication notification board in the controller unit and the plurality of solenoid valves are located within the accommodation space.

6. A side-suction and bottom-supporting gripper, comprising:
a separate valves-controlled gripper, comprising:
a main mounting plate, wherein a cavity structure is formed in the main mounting plate, wherein a plurality of first mounting holes in a first matrix arrangement are provided on a front side surface of the main mounting plate, and wherein a plurality of second mounting holes in a second matrix arrangement are provided on a back side surface of the main mounting plate;
a plurality of suckers, wherein the plurality of suckers is provided in the plurality of first mounting holes; and
a plurality of solenoid valves, wherein the plurality of solenoid valves are provided in the plurality of second mounting holes, and wherein a plurality of air holes of the plurality of suckers are in communication with or disconnected from the cavity structure through the plurality of solenoid valves;
a gripper main structure;
a sucker structure, wherein the sucker structure is provided with the separate valves-controlled gripper, wherein the separate valves-controlled gripper is used to suck a target box, and wherein the sucker structure is provided on the gripper main structure and is movable in a first direction;
a bottom-supporting mechanism, wherein the bottom-supporting mechanism is located on the gripper main structure, and wherein the bottom-supporting mechanism is movable in a second direction opposite to the first direction; and
an actuator module, wherein the actuator module is connected to the sucker structure and to the bottom-supporting mechanism through a driving transmission mechanism, and wherein the actuator module is used to drive the sucker structure and the bottom-supporting mechanism to move in opposite directions simultaneously.

7. The side-suction and bottom-supporting gripper of claim 6,
wherein when the separate valves-controlled gripper grips the target box by applying suction, the actuator module drives the separate valves-controlled gripper to move from a front end of the gripper main structure to a rear end of the gripper main structure, and the bottom-supporting mechanism protrudes from the front end of the gripper main structure; and
wherein when releasing the target box, the actuator module drives the separate valves-controlled gripper to move from the rear end of the gripper main structure to the front end of the gripper main structure to push out the target box, while the bottom-supporting mechanism retracts into the gripper main structure.

8. The side-suction and bottom-supporting gripper of claim 6, wherein the driving transmission mechanism comprises:
a driving wheel;
a driven wheel; and
a transmission belt;
wherein the driving wheel is provided on a transmission shaft of the actuator module;
wherein the driven wheel is provided at the front end of the gripper main structure;
wherein the driving wheel is connected to the driven wheel through the transmission belt; and
wherein the sucker structure is connected to a first side of the transmission belt, and the bottom-supporting mechanism is connected to a second side of the transmission belt different from the first side of the transmission belt.

9. The side-suction and bottom-supporting gripper of claim 6,
wherein the gripper main structure comprises a supporting base structure and a vertical installation plate;
wherein the vertical installation plate is connected to a rear end of the supporting base structure, and the vertical installation plate is provided with a robot-connecting flange;
wherein the supporting base structure is provided with a gripper-guiding mechanism and a bottom-supporting and guiding mechanism;
wherein the bottom-supporting mechanism is provided on the bottom-supporting and guiding mechanism and is capable of sliding along the bottom-supporting and guiding mechanism; and
wherein the sucker structure is provided on the gripper-guiding mechanism and is capable of sliding along the gripper-guiding mechanism.

10. The side-suction and bottom-supporting gripper of claim 9,
wherein the gripper-guiding mechanism comprises a first guide rail, a first slider, a second guide rail, and a second slider;
wherein the first guide rail and the second guide rail are provided on a first pair of supporting rods of the supporting base structure;
wherein the sucker structure is connected to the first guide rail through the first slider;
wherein the sucker structure is connected to the second guide rail through the second slider; and
wherein the sucker structure is capable of sliding along the first guide rail and the second guide rail.

11. The side-suction and bottom-supporting gripper of claim 9,
wherein the bottom-supporting and guiding mechanism comprises a third guide rail, a third slider, a fourth guide rail, and a fourth slider;
wherein the third guide rail and the fourth guide rail are provided on a second pair of supporting rods of the supporting base structure;
wherein the bottom-supporting mechanism is connected to the third guide rail through the third slider;
wherein the bottom-supporting mechanism is connected to the fourth guide rail through the fourth slider; and
wherein the bottom-supporting mechanism is capable of sliding along the third guide rail and the fourth guide rail.

12. The side-suction and bottom-supporting gripper of claim 11,
wherein the bottom-supporting mechanism comprises a guiding rod, a first bottom-supporting plate, a first connecting plate, a second bottom-supporting plate, and a second connecting plate;
wherein a plurality of front ends of the first bottom-supporting plate and the second bottom-supporting plate are connected to the guiding rod;
wherein the first bottom-supporting plate is connected to the third slider through the first connecting plate; and
wherein the second bottom-supporting plate is connected to the fourth slider through the second connecting plate.

13. The side-suction and bottom-supporting gripper of claim 6,
wherein the actuator module comprises a driving motor, a power output gear, a power transmission gear, and a transmission shaft;
wherein the driving motor is provided at a lower side of the gripper main structure, and the transmission shaft is provided on a plurality of bearings at a rear end of the gripper main structure;
wherein the power transmission gear is provided on the transmission shaft; and
wherein the driving motor is used to drive the transmission shaft to rotate through the power output gear and the power transmission gear in sequence.

14. The side-suction and bottom-supporting gripper of claim 9,
wherein the supporting base structure comprises a front supporting frame, a rear supporting frame, a first supporting rod, a second supporting rod, a third supporting rod, and a fourth supporting rod;
wherein a front end of the first supporting rod is connected to a first end of the front supporting frame, and a rear end of the first supporting rod is connected to a first end of the rear supporting frame, a front end of the second supporting rod is connected to a second end of the front supporting frame, and a rear end of the second supporting rod is connected to a second end of the rear supporting frame; and
wherein the third supporting rod and the fourth supporting rod are provided between the first supporting rod and the second supporting rod, a front end of the third supporting rod is connected to the front supporting frame, a rear end of the third supporting rod is connected to the rear supporting frame, a front end of the fourth supporting rod is connected to the front supporting frame, and a rear end of the fourth supporting rod is connected to the rear supporting frame.

15. A loading-unloading robot, comprising
a separate valves-controlled gripper, comprising:
a main mounting plate, wherein a cavity structure is formed in the main mounting plate, wherein a plurality of first mounting holes in a first matrix arrangement are provided on a front side surface of the main mounting plate, and wherein a plurality of second mounting holes in a second matrix arrangement are provided on a back side surface of the main mounting plate;
a plurality of suckers, wherein the plurality of suckers is provided in the plurality of first mounting holes; and
a plurality of solenoid valves, wherein the plurality of solenoid valves are provided in the plurality of second mounting holes, and wherein a plurality of air holes of the plurality of suckers are in communication with or disconnected from the cavity structure through the plurality of solenoid valves;
a robotic manipulator; and
a mobile base;
wherein the separate valves-controlled gripper is provided at an end of the robotic manipulator; and
wherein the robotic manipulator is provided on the mobile base, and
wherein the mobile base is used to drive the robotic manipulator to move.
